(19) United States
(12) Patent Application Publication
(10) Pub. No.: US 2013/0282648 A1
(43) Pub. Date: Oct. 24, 2013

(54) DETERMINISTIC FINITE AUTOMATON MINIMIZATION

(71) Applicants: Alexis Guanella, Rueschlikon (CH); Jan van Lunteren, Rueschlikon (CH)

(72) Inventors: Alexis Guanella, Rueschlikon (CH); Jan van Lunteren, Rueschlikon (CH)

(73) Assignee: International Business Machines Corporation, Armonk, NY (US)

(21) Appl. No.: 13/449,675

(22) Filed: Apr. 18, 2012

(51) Int. Cl. G06N 5/02

(52) U.S. Cl. 706/59

(57) ABSTRACT

Deterministic finite automaton (DFA) minimization includes representing a DFA as a data structure including a plurality of states, incoming transitions for each state, and outgoing transitions for each state. A state of the plurality of states is selected as a selected state. The incoming transitions are analyzed for the selected state. A computer determines whether source states of the incoming transitions for the selected state include a pair of equivalent states. The pair of equivalent states is merged based on determining that two of the source states of the incoming transitions for the selected state form the pair of equivalent states.

### BACKGROUND

This disclosure relates generally to the field of deterministic finite automatons (DFAs), and more particularly to efficient DFA minimization.

A deterministic finite automaton (DFA) is a finite state machine that accepts or rejects finite strings of symbols and produces a unique computation or run of the automaton for each input string. A DFA may be illustrated as a state diagram but can be implemented in hardware or software. DFAs recognize a set of regular languages, which are formal languages that can be expressed using regular expressions. In formal language theory, regular expressions consist of constants and operators that denote sets of strings and operations over these sets. DFAs are useful for doing lexical analysis and pattern matching. DFAs can be built from nondeterministic finite automata through powerset construction. A powerset of a set of values includes all subsets of the values, including an empty set and a complete set of the values.

In systems configured to perform massive regular expression matching at high speed, scaling problems may be observed that prevent known DFA processing techniques and functions from working efficiently. For example, regular expression scanners involving a few thousand patterns for virus or intrusion detection can be dramatically slowed as a growing number of new virus and intrusion patterns are added. DFAs can be simplified using DFA minimization, which transforms a given DFA into an equivalent DFA with a minimum number of states. Two DFAs may be deemed equivalent if they describe the same regular language.

In a typical pattern scanner, regular expressions involved in scanning are first converted into non-deterministic finite automatons (NFAs) by a pattern compiler, which are then combined. This is depicted in the example sequence 100 of FIG. 1, for two regular expressions, “.*reg” and “.*exs?”, where NFAs 102 and 104 are combined to form composite NFA 106. Composite NFA 106 can be mapped on a DFA using the powerset algorithm or a similar algorithm to produce a composite DFA 202 as depicted in the example of FIG. 2. Due to the nature of the algorithms used in this sequence, the composite DFA 202 is not minimal (i.e., does not have a minimum number of states). Therefore, a minimization step is performed to minimize the composite DFA 202, resulting in minimized DFA 204 of FIG. 2.

Pattern matching functions involving huge numbers of regular expressions can result in very large DFAs. For these very large DFAs, conventional DFA minimization functions can take an extremely long time (e.g., hours or days) and consume large amounts of memory.

### BRIEF SUMMARY

In one aspect, a computer-implemented method for deterministic finite automaton (DFA) minimization includes representing a DFA as a data structure including a plurality of states, incoming transitions for each state, and outgoing transitions for each state. A state of the plurality of states is selected as a selected state. The incoming transitions are analyzed for the selected state. A computer determines whether source states of the incoming transitions for the selected state include a pair of equivalent states. The pair of equivalent states is merged based on determining that two of the source states of the incoming transitions for the selected state form the pair of equivalent states.

In another aspect, a computer program product comprising a computer readable storage medium containing computer code that, when executed by a computer, implements a method for deterministic finite automaton (DFA) minimization. The method includes representing a DFA as a data structure including a plurality of states, incoming transitions for each state, and outgoing transitions for each state. A state of the plurality of states is selected as a selected state. The incoming transitions are analyzed for the selected state. The method determines whether source states of the incoming transitions for the selected state include a pair of equivalent states. The pair of equivalent states is merged based on determining that two of the source states of the incoming transitions for the selected state form the pair of equivalent states.

In another aspect, a computer system for deterministic finite automaton (DFA) minimization includes a memory having a DFA represented in a DFA data structure and a processor. The DFA data structure includes a plurality of states, incoming transitions for each state, and outgoing transitions for each state. The processor is configured to select a state of the plurality of states as a selected state, analyze the incoming transitions for the selected state, and determine whether source states of the incoming transitions for the selected state include a pair of equivalent states. The processor is further configured to merge the pair of equivalent states based on determining that two of the source states of the incoming transitions for the selected state form the pair of equivalent states.

Additional features are realized through the techniques of the present exemplary embodiment. Other embodiments are described in detail herein and are considered a part of what is claimed. For a better understanding of the features of the exemplary embodiment, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 illustrates an example of a sequence of forming a composite NFA.

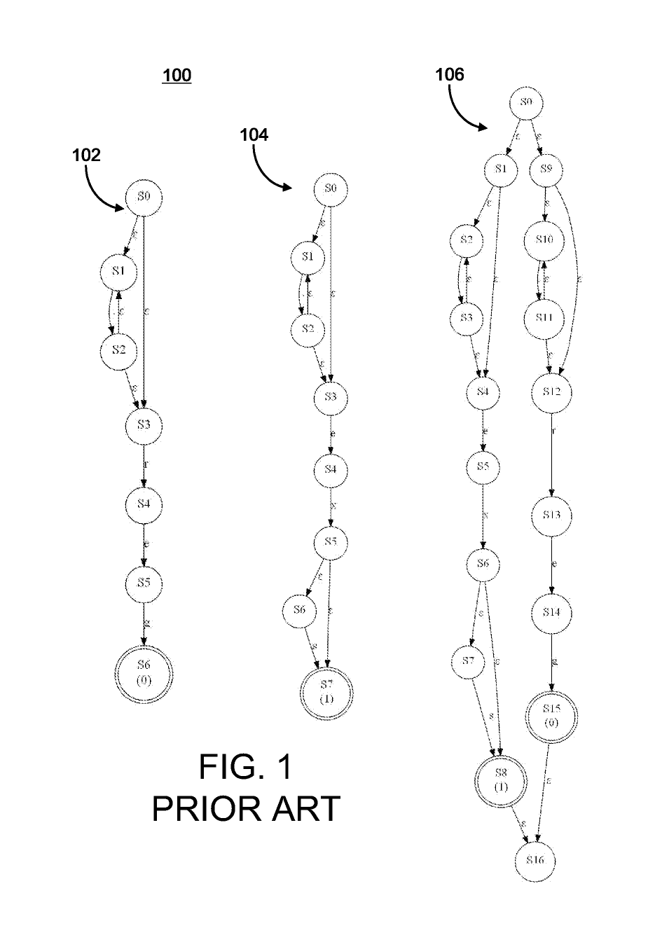

FIG. 2 illustrates an example of a sequence of mapping the composite NFA of FIG. 1 to a DFA and minimizing the DFA.

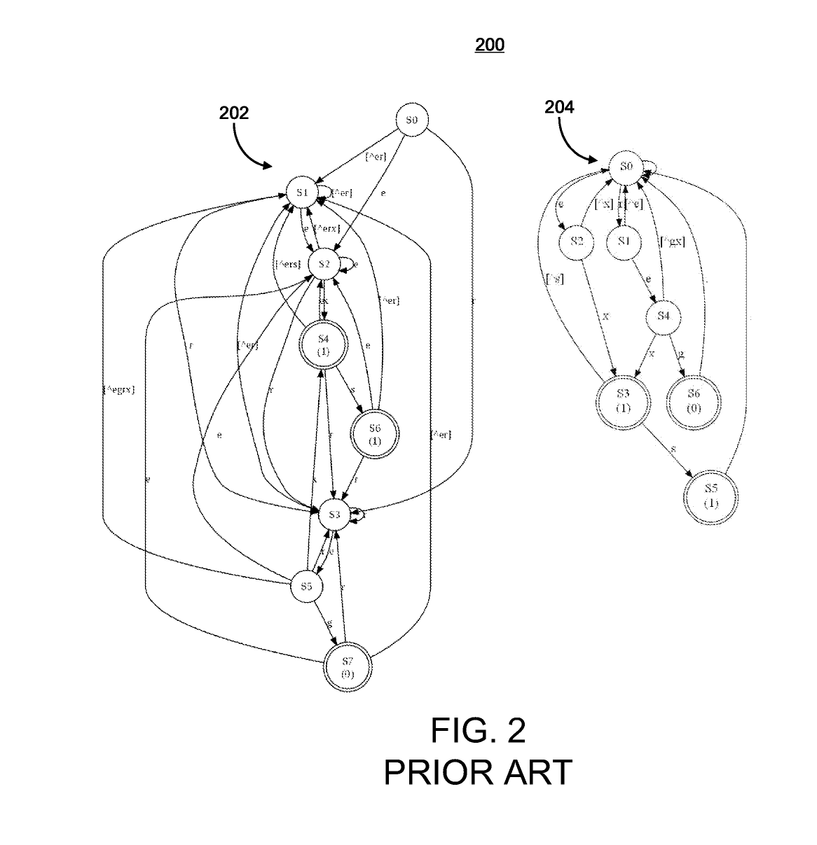

FIG. 3 illustrates a flowchart of an embodiment of a method of DFA minimization.

FIG. 4 illustrates a flowchart of an embodiment of a method of merging state pairs for DFA minimization.

FIG. 5A illustrates an example of a sequence of applying a first-stage minimization to a DFA.

FIG. 5B continues the example of FIG. 5A illustrating the sequence of applying the first-stage minimization to the DFA.

FIG. 6 is a schematic block diagram illustrating an embodiment of a computer that may be used in conjunction with a method for DFA minimization.

### DETAILED DESCRIPTION

Embodiments of systems and methods for deterministic finite automaton (DFA) minimization are provided, with exemplary embodiments being discussed below in detail. A multi-stage approach for realizing fast and efficient DFA minimization that can scale to very large DFAs (e.g., involving hundreds of millions of states) partitions DFA minimization into an initial minimization stage followed by a higher precision final minimization stage. The first stage applies a simple and fast heuristic for initial minimization to output a first-stage minimized DFA but does not necessarily result in an optimal minimization. The second stage is performed on the first-stage minimized DFA, and involves a known minimization algorithm to produce a minimized DFA. The second stage can apply, for example, a table-filling DFA minimization algorithm or a Hoperoft DFA minimization algorithm, which are much slower and more memory consuming algorithms than the first-stage minimization algorithm, but achieve optimal DFA minimization. An example of a table-filing DFA minimization algorithm is described in “Automata Theory, Languages and Computation”; Hoperoft, J. E., Motwani, R., Ullman, J. D. 3rd Edition, 2007. An example of the above referenced Hoperoft DFA minimization algorithm is described in “An n log n algorithm for minimizing states in a finite automaton”; Hoperoft, J. Theory of Machines and Computations, Academic Press, 1971. Multi-stage minimization provides overall improved memory efficiency and speed as compared to using only a known minimization algorithm, while also achieving an optimal solution.

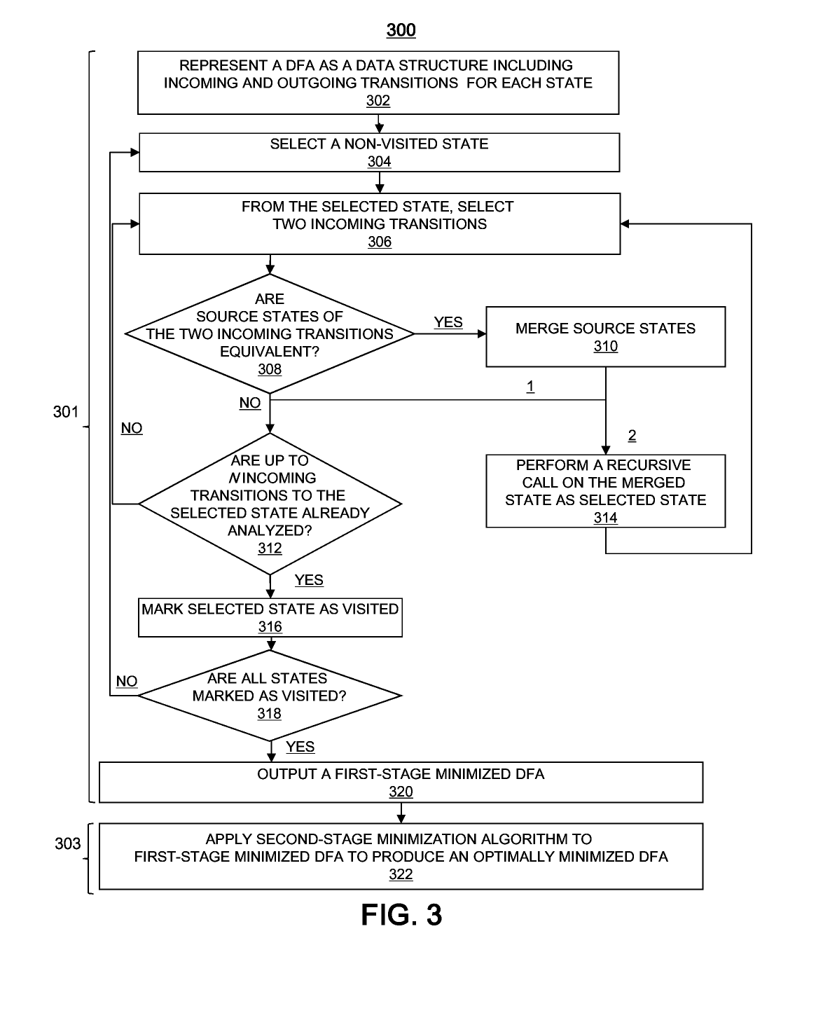

FIG. 3 illustrates a flowchart of an embodiment of a method 300 of DFA minimization. The method 300 includes a first-stage DFA minimization 301 and a second-stage DFA minimization 303. In the example of FIG. 3, the first-stage DFA minimization 301 includes blocks 302, 304, 306, 308, 310, 312, 314, 316, 318, 320. The second-stage DFA minimization 303 includes block 322 in the example of FIG. 3.

At block 302, a DFA is represented as a DFA data structure including incoming transitions and outgoing transitions for each state. Each state of the DFA can include a table or list that contains pointers to all incoming transitions to the state, as well as all outgoing transitions for transitioning to a next state. The incoming transitions define source states that transition to a given state, and the outgoing transitions define one or more transition conditions to advance from the given state to a next state. The DFA data structure can be stored in computer memory.

At block 304, a non-visited state of the DFA is selected. This state can be selected at random from all available states, or based on some criteria, for example, the state with the largest number of incoming transitions or lowest number of outgoing transitions. A Boolean variable associated with each state is used to ensure that each state is visited only once.

At block 306, two incoming transitions are selected.

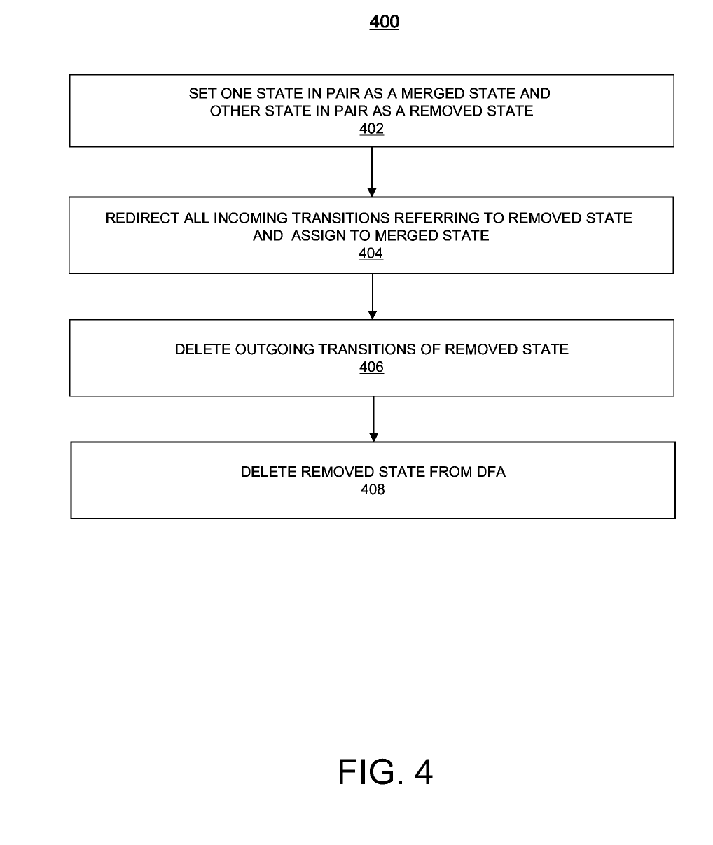

At block 308, a check is performed to determine whether the source states corresponding to the incoming transitions are equivalent. In order for a pair of states to be deemed equivalent states, all of the transitions for both states may involve equivalent pairs of transitions, with one transition related to one state and the other transition related to the other state, such that each pair of transitions involves the same input value(s)/condition(s) and transitions to the same next state. In addition, if results are associated with the states, then these must be the same. If states are equivalent, then these are merged at block 310. Details of an embodiment of a merging process are described further herein in reference to FIG. 4. If states are not equivalent, the algorithm continues on block 312.

When a pair of states is merged (block 310), all referring transitions to one of the equivalent states are redirected to the other equivalent state followed by the removal of the former equivalent state and its outgoing transitions. The remaining equivalent state is referred to as a merged state. After merging the algorithm continues to block 312, and then recursively visits block 314. In block 314, the merged state becomes the selected state such that upon return to block 306, the recursive analysis is applied on the merged state.

To ensure a linear complexity (O(n)) of the algorithm, the number of comparisons of incoming transitions must be restricted to a constant N. This is performed at block 312. The maximum number of incoming transitions, N, can be set to a number of different possible input characters, for example, a maximum value of 256. Additional incoming transitions greater than N are ignored. When all or a maximum of N incoming transitions to the selected state have been analyzed, the selected state is marked as visited at block 316.

At block 318, if additional states remain to be analyzed, the process flow returns to block 304 to continue to search for pairs of equivalent states to merge and further minimize the DFA. Once all states have been analyzed at block 318, a first-stage minimized DFA is output at block 320 as the resulting DFA based on merging at least one pair of equivalent states. A second-stage DFA minimization algorithm is applied to the first-stage minimized DFA to produce a minimized DFA. As previously described, the second-stage DFA minimization algorithm can be a known minimization algorithm, such as a table-filling DFA minimization algorithm or a Hoperoft DFA minimization algorithm, which produces a final optimal minimized DFA. It is noted that the table-filling DFA minimization algorithm has a complexity of O(n²), and the Hoperoft DFA minimization algorithm has a complexity of O(n log n), where n is the number of states. Therefore, it can be seen that applying the first-stage minimization with a complexity of about O(n) can rapidly reduce a number of states in the DFA, such that a much smaller number of states is passed to the next stage DFA minimization algorithm that has a much greater complexity of more than O(n) (a non-linear complexity). It will be understood that two or more blocks of the method 300 can be combined, and one or more blocks of the method 300 can be implemented implicitly.

FIG. 4 illustrates a flowchart of an embodiment of a method 400 of merging state pairs for DFA minimization. The method 400 may be applied as part of block 310 of FIG. 3. At block 402, one state in a pair of equivalent states is set as a merged state and the other state in the pair of equivalent states is set as a removed state. At block 404, all incoming transitions referring to the removed state are redirected to the merged state. At block 406, outgoing transitions of the removed state are deleted from the DFA. At block 408, the removed state is deleted from the DFA. It will be understood that two or more blocks of the method 400 can be combined, and one or more blocks of the method 400 can be implemented implicitly.

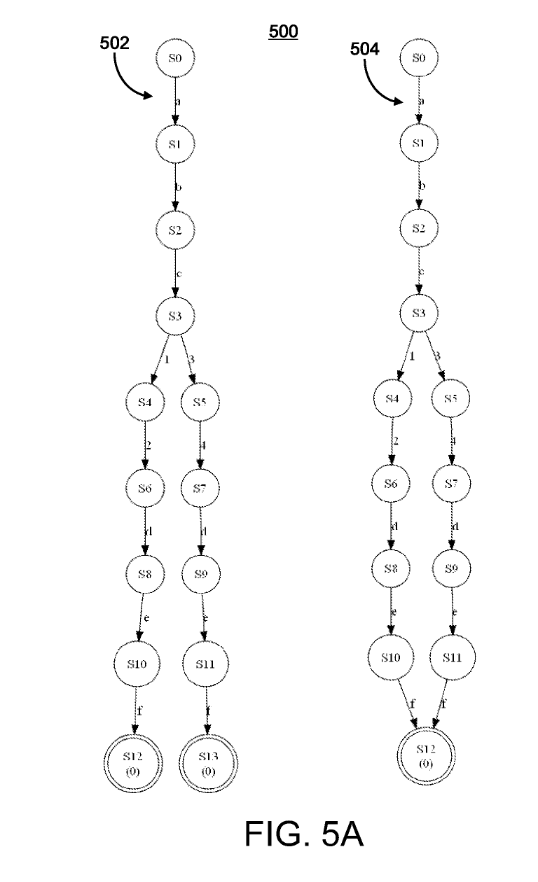

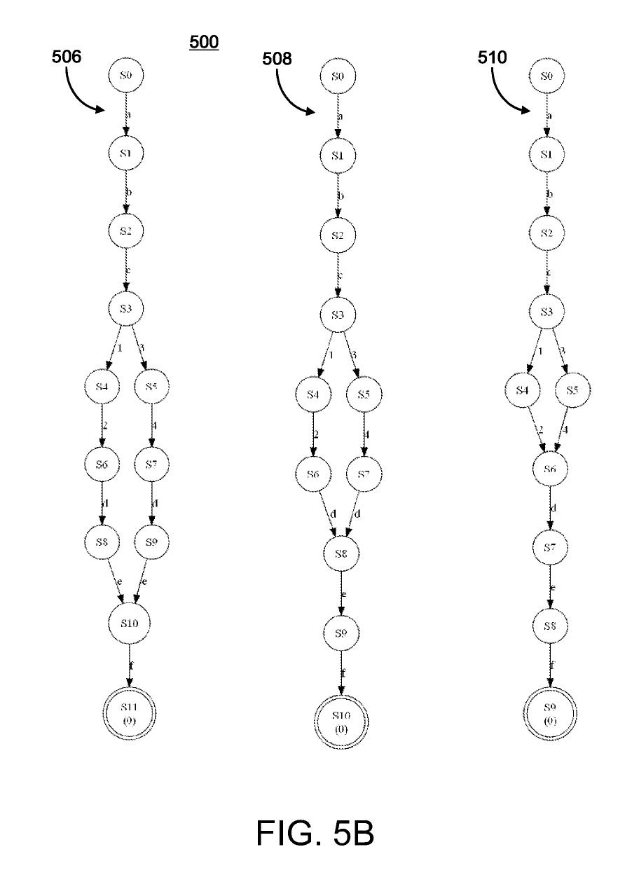

FIGS. 5A and 5B illustrate an example of a sequence 500 of applying a first-stage DFA minimization to a DFA 502. The first-stage DFA minimization may be the first-stage DFA minimization 301 of FIG. 3. DFA 502 is an example of a non-minimized DFA to search for matches to a regular-expression pattern “abc12def|abc34def”. DFA 502 includes states S0, S1, S2, S3, S4, S5, S6, S7, S8, S9, S10, S11, S12, and S13. DFA 502 includes a number of transitions which are depicted for each state of the DFA 502 in FIG. 5A. DFA 502 transitions from S0 to S1 if a match for “a” is detected. DFA 502 transitions from S1 to S2 if a match for “b” is detected. DFA 502 transitions from S2 to S3 if a match for “c” is detected. DFA 502 transitions from S3 to S4 if a match for “1” is detected and to S5 if a match for “3” is detected. DFA 502 transitions from S4 to S6 if a match for “2” is detected. DFA 502 transitions from S6 to S8 if a match for “d” is detected. DFA 502 transitions from S8 to S10 if a match for “e” is detected. DFA 502 transitions from S10 to S12 if a match for “f” is detected. DFA 502 transitions from S5 to S7 if a match for “4” is detected. DFA 502 transitions from S7 to S9 if a match for “d” is detected. DFA 502 transitions from S9 to S11 if a match for “e” is detected. DFA 502 transitions from S11 to S13 if a match for “f” is detected. If either pattern “abc12def” or “abc34def” is detected, a pattern identifier 0 is reported in states S12 and S13 of DFA 502.

While outgoing transitions for each state are depicted for DFA 502, the DFA data structure also tracks incoming transitions for each state. For example, state S1 of DFA 502 has an incoming transition from state S0 of DFA 502 and an outgoing transition for transitioning to state S2 of DFA 502 if a match for “b” is detected. Each state need not track the condition that must be satisfied for the incoming transitions, only a source state of each incoming transition may be tracked at each state. Accordingly, state S1 of DFA 502 need not a know that it is transitioned to when a match for “a” is detected as state S0 of DFA 502; rather, tracking that an incoming transition can come from state S0 of DFA 502 may be sufficient since the outgoing transition of state S0 of DFA 502 can be recursively accessed from state S1 of DFA 502. Alternatively, the incoming transitions tracked at a given state can include the complete transitions, including conditions, used by a source state transitioning to the given state.

The first-stage DFA minimization 301 of FIG. 3 selects a state to analyze at block 304 and a pair of incoming transitions at block 306, and then checks for pairs of equivalent states in block 308. In the example of FIG. 5A, state S0 of DFA 502 is the first selected state. Default transitions, i.e. transitions to the default state S0, are not depicted in figure FIG. 5A to keep the diagram simple, but these do exist in the actual DFA representation. The first-stage DFA minimization 301 finds states S12 and S13 of DFA 502 (which have default transitions to the default state S0 that are not shown in the diagram) to be equivalent. In this case, both states S12 and S13 of DFA 502 have outgoing default transitions and correspond to the same result. At block 310 of FIG. 3, states S12 and S13 of DFA 502 are merged. In this case state S13 of DFA 502 is the removed state and all incoming transitions referring to state S13 of DFA 502 are redirected to state S12 of DFA 502. The equivalent state pair merger results in a modified DFA shown as DFA 504 FIG. 5A. The selected state becomes the newly merged state S12 of DFA 504.

At block 314 of FIG. 3, a recursive call is performed back to block 306 and incoming transitions to state S12 of DFA 504 are analyzed. Source states of incoming transitions to state S12 of DFA 504, in this case states S10 and S11 of DFA 504, are checked for being equivalent at block 308. In this example, states S10 and S11 of DFA 504 are deemed to be equivalent and are merged, since both states S10 and S11 of DFA 504 transition to state S12 of DFA 504 if a match for “f” is detected. At block 310, state S11 of DFA 504 is a removed state and all incoming transitions to state S11 of DFA 504 are redirected to state S10 of DFA 504 as part of the merge. The equivalent state pair merger results in a modified DFA shown as DFA 506 in FIG. 5B. The selected state becomes newly merged state S10 of DFA 506. Note that in this example and in subsequent example DFAs, subsequent states are renumbered such that state S12 of DFA 504 becomes state S11 of DFA 506. The process continues and results in the merging of equivalent states S8 and S9 of DFA 506 into state S8 of DFA 508 in FIG. 5B. States S6 and S7 of DFA 508 are merged into state S6 of DFA 510 in FIG. 5B. In DFA 510 no other equivalent state pairs can be found; therefore, according to blocks 318 and 320 of FIG. 3 all states have been analyzed and DFA 510 is the first-stage minimized DFA. It will be understood that a DFA processed by first-stage DFA minimization 301 can be substantially more complex than the example of FIGS. 5A and 5B.

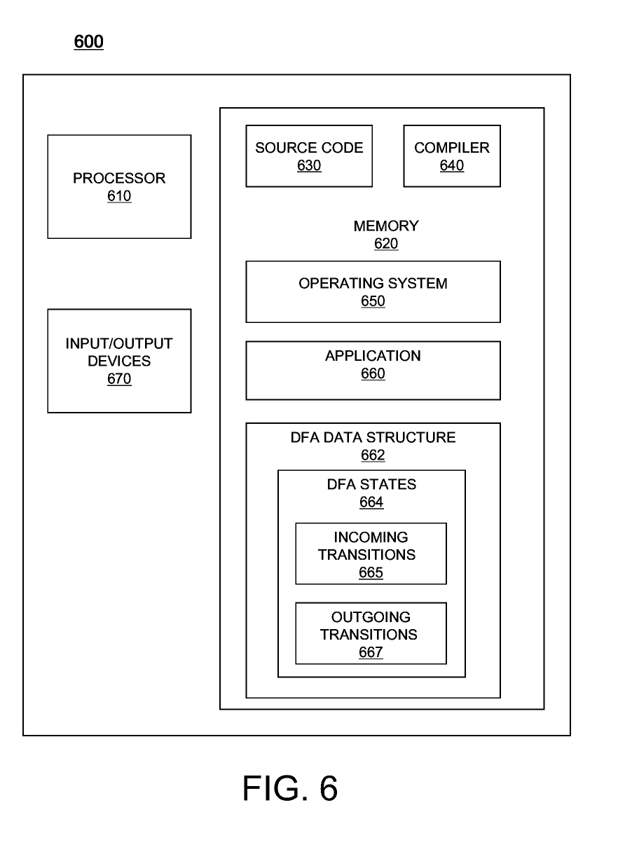

FIG. 6 illustrates an example of a computer 600 which may be utilized by exemplary embodiments of a method for DFA minimization as embodied in software. Various operations discussed above may utilize the capabilities of the computer 600. One or more of the capabilities of the computer 600 may be incorporated in any element, module, application, and/or component discussed herein.

The computer 600 includes, but is not limited to, PCs, workstations, laptops, PDAs, palm devices, servers, storages, and the like. Generally, in terms of hardware architecture, the computer 600 may include one or more processors 610, memory 620, and one or more input and/or output (I/O) devices 670 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 610 is a hardware device for executing software that can be stored in the memory 620. The processor 610 can be virtually any custom made or commercially available processor, a central processing unit (CPU), a digital signal processor (DSP), or an auxiliary processor among several processors associated with the computer 600, and the processor 610 may be a semiconductor based microprocessor (in the form of a microchip) or a macroprocessor.

The memory 620 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 620 may incorporate electronic, magnetic, optical, and/or other types of storage media. Note that the memory 620 can have a distributed architecture, where various components are situated remote from one another, but can be accessed by the processor 610.

The software in the memory 620 may include one or more separate programs, each of which comprises an ordered listing of executable instructions for implementing logical functions. The software in the memory 620 includes a suitable operating system (O/S) 650, compiler 640, source code 630, and one or more applications 660 in accordance with exemplary embodiments. As illustrated, the application 660 comprises numerous functional components for implementing the features and operations of the exemplary embodiments. The application 660 of the computer 600 may represent various applications, computational units, logic, functional units, processes, operations, virtual entities, and/or modules in accordance with exemplary embodiments, but the application 660 is not meant to be a limitation.

In an embodiment, the memory 620 also includes a DFA data structure 662 that can include DFA states 664, incoming transitions 665, and outgoing transitions 667. The DFA data structure 662 may also include other values or limits (not depicted), such as a maximum number of incoming transitions that can be processed. The methods 300 and 400 of FIGS. 3 and 4 can use the DFA data structure 662, DFA states 664, incoming transitions 665, and outgoing transitions 667 to implement the methods 300 and 400 in the computer 600. DFAs such as DFAs 502-510 of FIGS. 5A and 5B can be represented and managed using one or more DFA data structures 662.

The operating system 650 controls the execution of other computer programs, and provides scheduling, input-output control, file and data management, memory management, and communication control and related services. It is contemplated by the inventors that the application 660 for implementing exemplary embodiments may be applicable on all commercially available operating systems.

Application 660 may be a source program, executable program (object code), script, or any other entity comprising a set of instructions to be performed. When a source program, then the program is usually translated via a compiler (such as the compiler 640), assembler, interpreter, or the like, which may or may not be included within the memory 620, so as to operate properly in connection with the O/S 650. Furthermore, the application 660 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 670 may include input devices such as, for example but not limited to, a mouse, keyboard, scanner, microphone, camera, etc. Furthermore, the I/O devices 670 may also include output devices, for example but not limited to a printer, display, etc. Finally, the I/O devices 670 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 670 also include components for communicating over various networks, such as the Internet or intranet.

If the computer 600 is a PC, workstation, intelligent device or the like, the software in the memory 620 may further include a basic input output system (BIOS) (omitted for simplicity). The BIOS is a set of essential software routines that initialize and test hardware at startup, start the O/S 650, and support the transfer of data among the hardware devices. The BIOS is stored in some type of read-only-memory, such as ROM, PROM, EPROM, EEPROM or the like, so that the BIOS can be executed when the computer 600 is activated.

When the computer 600 is in operation, the processor 610 is configured to execute software stored within the memory 620, to communicate data to and from the memory 620, and to generally control operations of the computer 600 pursuant to the software. The application 660 and the O/S 650 are read, in whole or in part, by the processor 610, perhaps buffered within the processor 610, and then executed.

When the application 660 is implemented in software it should be noted that the application 660 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 660 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 660 is implemented in hardware, the application 660 can be implemented with any one or a combination of the following technologies, which are well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The technical effects and benefits of exemplary embodiments include deterministic finite automaton minimization using multiple optimization stages to merge and reduce DFA states before running a secondary minimization algorithm.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1.-7. (canceled)

8. A computer program product comprising a computer readable storage medium containing computer code that, when executed by a computer, implements a method for deterministic finite automaton (DFA) minimization, wherein the method comprises:
representing a DFA as a data structure comprising a plurality of states, incoming transitions for each state, and outgoing transitions for each state;
selecting a state of the plurality of states as a selected state;
analyzing the incoming transitions for the selected state;
determining, by the computer, whether source states of the incoming transitions for the selected state include a pair of equivalent states; and
merging the pair of equivalent states based on determining that two of the source states of the incoming transitions for the selected state form the pair of equivalent states.

9. The computer program product according to claim 8, further comprising:
reducing the pair of equivalent states to a merged state;
setting the merged state as the selected state; and
searching for additional pairs of equivalent states by recursively analyzing the incoming transitions of the selected state.

10. The computer program product according to claim 9, further comprising limiting the searching to a maximum number of the incoming transitions of the selected state.

11. The computer program product according to claim 9, further comprising:
setting one state in the pair of equivalent states to a removed state; and
redirecting incoming transitions referring to the removed state and assigning the incoming transitions to the merged state.

12. The computer program product according to claim 11, further comprising:
deleting outgoing transitions from the removed state; and
deleting the removed state from the DFA.

13. The computer program product according to claim 8, further comprising:
outputting a first-stage minimized DFA based on merging at least one pair of equivalent states; and
applying a second-stage DFA minimization to the first-stage minimized DFA to produce a minimized DFA.

14. The computer program product according to claim 13, wherein the second-stage DFA minimization is an optimal minimization algorithm having a non-linear complexity greater than O(n).

15. A computer system for deterministic finite automaton (DFA) minimization, the computer system comprising:
a memory comprising a DFA represented in a DFA data structure, the DFA data structure comprising a plurality of states, incoming transitions for each state, and outgoing transitions for each state; and
a processor configured to:
select a state of the plurality of states as a selected state;
analyze the incoming transitions for the selected state;
determine whether source states of the incoming transitions for the selected state include a pair of equivalent states; and
merge the pair of equivalent states based on determining that two of the source states of the incoming transitions for the selected state form the pair of equivalent states.

16. The computer system of claim 15, wherein the computer system is further configured to:
reduce the pair of equivalent states to a merged state;
set the merged state as the selected state; and
search for additional pairs of equivalent states by recursively analyzing the incoming transitions of the selected state.

17. The computer system of claim 16, wherein the computer system is further configured to limit the search to a maximum number of the incoming transitions of the selected state.

18. The computer system of claim 16, wherein the computer system is further configured to:
set one state in the pair of equivalent states to a removed state;
redirect incoming transitions referring to the removed state and assign the incoming transitions to the merged state;
delete outgoing transitions from the removed state; and
delete the removed state from the DFA.

19. The computer system of claim 15, wherein the computer system is further configured to:
output a first-stage minimized DFA based on merging at least one pair of equivalent states; and
apply a second-stage DFA minimization to the first-stage minimized DFA to produce a minimized DFA.

20. The computer system of claim 19, wherein the second-stage DFA minimization is an optimal minimization algorithm having a non-linear complexity greater than O(n).
